(19) United States
(12) Patent Application Publication
(10) Pub. No.: US 2015/0248186 A1
(43) Pub. Date: Sep. 3, 2015

(54) TOUCH PANEL

(71) Applicant: Samsung Electro-Mechanics Co., Ltd., Suwon (KR)

(72) Inventors: Sang Hwan OH, Suwon (KR); Yoon Mi O, Suwon (KR); Tae Young KIM, Suwon (KR)

(73) Assignee: Samsung Electro-Mechanics Co., Ltd., Suwon (KR)

(21) Appl. No.: 14/266,260

(22) Filed: Apr. 30, 2014

(30) Foreign Application Priority Data
Mar. 3, 2014 (KR) 10-2014-0025213

(51) Int. Cl. G06F 3/047; G06F 3/044

(52) U.S. Cl. CPC G06F 3/047; G06F 3/044

(57) ABSTRACT

There is provided a touch panel including: a substrate; an electrode part including a plurality of electrodes formed on one surface of the substrate and formed of conductive lines having a mesh pattern; and a pad part including a plurality of pads connected to end portions of the plurality of electrodes and formed of conductive lines having a mesh pattern, wherein the conductive lines of the plurality of pads and the conductive lines of the plurality of electrodes may have the same line width.

### CROSS-REFERENCE TO RELATED APPLICATION

This application claims the benefit of Korean Patent Application No. 10-2014-0025213 filed on Mar. 3, 2014, with the Korean Intellectual Property Office, the disclosure of which is incorporated herein by reference.

### BACKGROUND

The present disclosure relates to a touch panel.

A touch sensing device such as a touchscreen, a touch pad, or the like, an input device attached to a display device to provide an intuitive user interface, has recently been widely used in various electronic devices such as cellular phones, personal digital assistants (PDAs), navigation devices, and the like. Particularly, as a demand for smartphones has recently increased, the use of a touchscreen allowing for a user interface to be variously implemented in a limited form factor has increased.

Touchscreens used in portable devices can be divided into resistive type touchscreens and capacitive type touchscreens, according to a method of sensing a touch applied thereto. With regard thereto, capacitive type touchscreens have relatively long lifespans and may easily allow for a user to interact therewith in various manners through touchscreen gestures or the like. Particularly, capacitive type touchscreens may allow for the implementation of a multi-touch interface, as compared with resistive type touchscreens, such that capacitive type touchscreens are widely used in devices such as smartphones, and the like.

The capacitive type touchscreen includes a plurality of electrodes having a predetermined pattern and defining a plurality of nodes at which changes in capacitance are generated by a touch. At the plurality of nodes distributed on a two-dimensional plane, a self-capacitance or mutual-capacitance change is generated by the touch. Coordinates of a touch may be calculated by applying a weighted average method, or the like, to the change in capacitance generated in the plurality of nodes.

In a touch panel according to the related art, a sensing electrode recognizing touches has been generally made of indium tin oxide (ITO). However, ITO, using indium as a raw material thereof, is relatively expensive, and consequently has low price competitiveness. In addition, world reserves of indium are expected to be severely depleted within the next decade, such that stable supply thereof may not be guaranteed in the future. Research into forming electrodes using opaque conductive lines has been conducted, wherein such electrodes formed of the conductive lines have greater levels of electrical conductivity, while a stable supply of the raw materials used in the manufacturing thereof may be guaranteed, as compared to the case of ITO and conductive polymers. However, since fine line widths, such as those of the conductive lines, require an etching rate different from that used in the formation of a pad formed of a metal, the conductive lines of electrodes disposed on the periphery of the pads may be disconnected.

The following Related Art Document (Patent Document 1), relating to a touch panel, discloses an electrode terminal formed of fine metal lines having a mesh pattern, but fails to disclose that a line width of a metal line of the electrode terminal is equal to a line width of a metal line of an electrode pattern.

### Related Art Document

(Patent Document 1) Japanese Patent Laid-Open Publication No. 2013-127658

### SUMMARY

An aspect of the present disclosure may provide a touch panel having a pad formed of conductive lines having a mesh pattern, in which a line width of the conductive line of the pad is equal to a line width of a conductive line of an electrode.

According to an aspect of the present disclosure, a touch panel may include: a substrate; an electrode part including a plurality of electrodes formed on one surface of the substrate and formed of conductive lines having a mesh pattern; and a pad part including a plurality of pads connected to end portions of the plurality of electrodes and formed of conductive lines having a mesh pattern, wherein the conductive lines of the plurality of pads and the conductive lines of the plurality of electrodes may have the same line width.

The conductive lines of the plurality of pads may have a line width of 2 μm to 10 μm.

The pad part may further include a quadrangular outline surrounding the plurality of pads.

The outline may have a line width of 2 μm to 30 μm.

The pad part may further include at least one auxiliary line spaced apart from the plurality of pads by a predetermined distance in a direction toward the electrode part.

The at least one auxiliary line may have the same line width as that of the conductive lines of the plurality of pads.

The plurality of pads may have an opening rate lower than that of the plurality of electrodes.

The plurality of pads may have an opening rate of 60% to 95%.

The conductive lines of the plurality of pads may be formed of at least one of silver (Ag), aluminum (Al), chrome (Cr), nickel (Ni), molybdenum (Mo), copper (Cu), and alloys thereof.

According to another aspect of the present disclosure, a touch panel may include: a substrate; an electrode part including a plurality of electrodes formed on one surface of the substrate and formed of conductive lines having a mesh pattern; and a pad part including a plurality of pads connected to end portions of the plurality of electrodes and formed of conductive lines having a mesh pattern and at least one auxiliary line spaced apart from the plurality of pads by a predetermined distance in a direction toward the electrode part.

The conductive lines of the plurality of pads and the conductive lines of the plurality of electrodes may have the same line width.

The conductive lines of the plurality of pads may have a line width of 2 μm to 10 μm.

The pad part may further include a quadrangular outline surrounding the plurality of pads.

The outline may have a line width of 2 μm to 30 μm.

The at least one auxiliary line may have the same line width as that of the conductive lines of the plurality of pads.

The plurality of pads may have an opening rate lower than that of the plurality of electrodes.

The plurality of pads may have an opening rate of 60% to 95%.

The conductive lines of the plurality of pads may be formed of at least one of silver (Ag), aluminum (Al), chrome (Cr), nickel (Ni), molybdenum (Mo), copper (Cu), and alloys thereof.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an exterior appearance of an electronic device including a touch panel according to an exemplary embodiment of the present disclosure;

FIG. 2 is a view illustrating a touch panel according to an exemplary embodiment of the present disclosure;

FIGS. 3 and 4 are views illustrating details of the touch panel according to the exemplary embodiment of FIG. 2;

FIGS. 5 through 7 are views illustrating a pad part according to various exemplary embodiments of the present disclosure; and

FIGS. 8A and 8B show simulation data according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

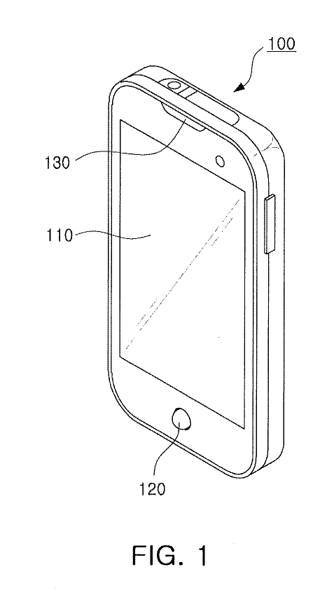

FIG. 1 is a perspective view illustrating an exterior appearance of an electronic device including a touch panel according to an exemplary embodiment of the present disclosure.

Referring to FIG. 1, an electronic device 100 according to the present exemplary embodiment may include a display device 110 displaying images, an input unit 120, an audio unit 130 for audio output, and a touchscreen device integrated with the display device 110, wherein the touchscreen device may include a touch panel.

As shown in FIG. 1, in the case of a mobile device, the touchscreen device may be generally provided in a state of being integrated with the display device and needs to have a degree of light transmissivity enough to allow an image displayed on the display device to be transmitted therethrough. Therefore, the touchscreen device may be obtained by forming electrodes using a material having electrical conductivity on a transparent substrate formed of a material such as a polyethylene terephthalate (PET) film, a polycarbonate (PC) film, a polyethersulfone (PES) film, a polyimide (PI) film, a polymethylmethacrylate (PMMA) film, a cyclo-olefin polymer (COP) film, a soda glass, or a tempered glass . A wiring pattern connected to the electrodes formed of the electrical conductive material may be disposed in a bezel region of the touchscreen device and be visually shielded by the bezel region.

Since it is assumed that the touchscreen device according to the exemplary embodiment of the present disclosure is operated as a capacitive type touchscreen, the touchscreen device may include a plurality of electrodes having a predetermined pattern. In addition, the touchscreen device according to the exemplary embodiment of the present disclosure may include a capacitance sensing circuit detecting capacitance changes generated in the plurality of electrodes, an analog-to-digital converting circuit converting an output signal of the capacitance sensing circuit into a digital value, and a calculating circuit determining a touch using the converted digital data.

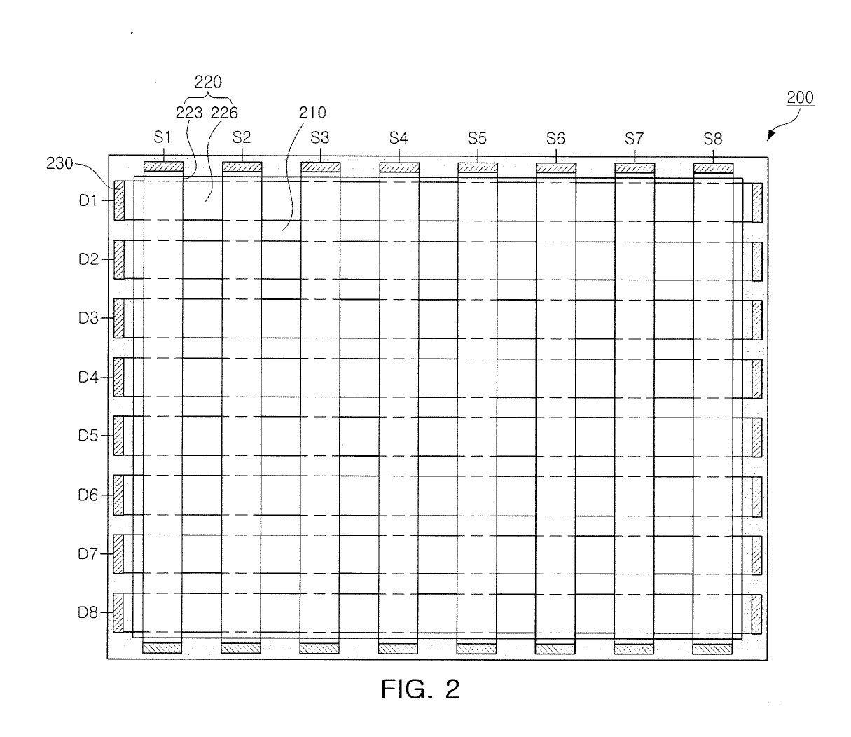

FIG. 2 is a view illustrating a touch panel according to an exemplary embodiment of the present disclosure.

Referring to FIG. 2, a touch panel 200 according to the present exemplary embodiment may include a substrate 210, electrode part 220 provided on the substrate 210, and a pad part 230 including a plurality of pads connected to the electrode part 220,. Although not shown in FIG. 2, the pad part 230 connected to the electrode part 220 may be electrically connected to a wiring pattern of a circuit board attached to one end of the substrate 210 through wirings and bonding pads. A controller integrated circuit may be mounted on the circuit board to detect a detection signal generated in the electrode part 220 and determine a touch through the detection signal.

The substrate 210 may be a transparent substrate on which the electrode part 220 is to be formed. Therefore, the substrate 210 maybe formed of a material such as a polyethylene terephthalate (PET) film, a polycarbonate (PC) film, a polyethersulfone (PES) film, a polyimide (PI) film, polymethylmethacrylate (PMMA) film, a cyclo-olefin polymer (COP) film, a soda glass, or a tempered glass, as described above.

The electrode part 220 may include first electrodes 223 extended in an X axis direction and second electrodes 226 extended in a Y axis direction. The first electrodes 223 and the second electrodes 226 may be provided on both surfaces of the substrate 210 or may be provided on different substrates intersecting with each other. In the case in which both of the first electrodes 223 and the second electrodes 226 are provided on one surface of the substrate 210, an insulating layer may be partially formed at intersection points between the first electrodes 223 and the second electrodes 226. Alternatively, the first electrodes 223 and the second electrodes 226 may be provided on different substrates intersecting with each other.

Further, a predetermined printed region may be provided in a region of the substrate 210, in which the pad part 230 is connected to the electrode part 220, other than a region of the substrate 210 in which the electrode part 220 is formed, the predetermined printed region visually shielding the wirings generally formed of an opaque metal material.

A touch sensing device electrically connected to the electrode part 220 to sense a touch may detect changes in capacitance generated in the electrode part 220 by the touch and sense the touch from the detected capacitance changes. The first electrodes 223 may be connected to channels defined as D1 to D8 in the controller integrated circuit to thereby receive a predetermined driving signal, and the second electrodes 226 may be connected to channels defined as S1 to S8 to thereby be used for the touch sensing device to detect a detection signal. Here, the controller integrated circuit may detect a change in mutual capacitance generated between the first and second electrodes 223 and 226 to obtain the detection signal and may be operated in a scheme in which it sequentially applies the driving signal to each of the first electrodes 223 and simultaneously detects the change in capacitance in the second electrodes 226.

When the driving signal is applied to the first electrodes 223 through the channels D1 to D8, the mutual capacitance may be generated between the first electrode 223 to which the driving signal is applied and the corresponding second electrode 226. When a touch object touches the touch panel, there is a change in the mutual capacitance generated between the first and second electrodes 223 and 226 that are adjacent to a region touched by the touch object. Changes in capacitance may be proportional to an area of an overlapped region between the touch object, the first electrode 223 to which the driving signal is applied, and the second electrode 226.

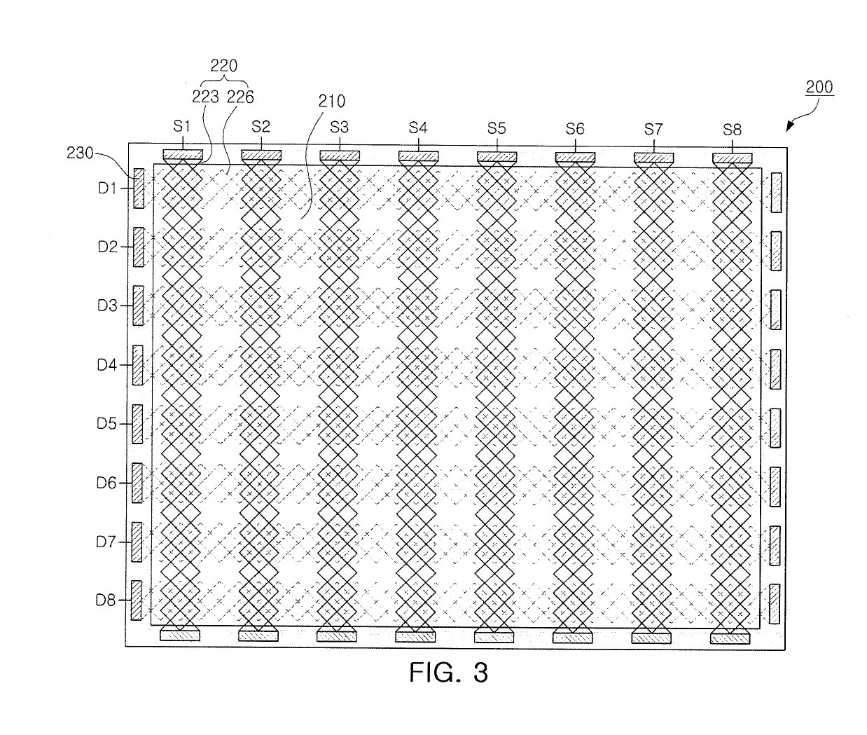

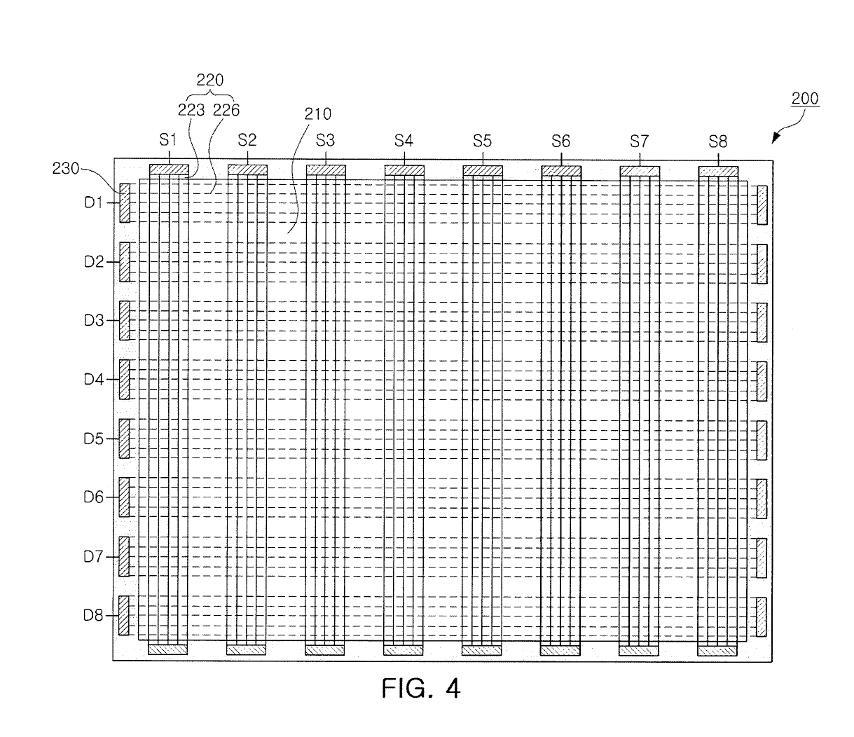

FIGS. 3 and 4 are views illustrating details of the touch panel according to the exemplary embodiment of FIG. 2. Referring to FIG. 3, the electrode part 220 may be formed of conductive lines, wherein the conductive lines configuring the electrode part 220 may have a net or mesh pattern. By arranging the conductive lines to have the net or mesh pattern, a phenomenon that patterning marks are viewed in a region in which existing indium-tin oxide (ITO) electrodes are present may be decreased, and transmissivity of the touch panel may be improved.

FIG. 3 illustrates that the conductive lines configuring the electrode part 220 have a rhombus or quadrangular shape, but the present disclosure is not limited thereto. The shape of the conductive lines may include a range which may be apparently or easily conceived of by a person skilled in the art such as a hexagonal shape, an octagonal shape, a diamond shape, an amorphous shape, and the like. For example, the conductive lines may be provided as straight lines as illustrated in FIG. 4.

The conductive lines configuring the electrode part 220 may be formed of any one of silver (Ag), aluminum (Al), chrome (Cr), nickel (Ni), molybdenum (Mo), copper (Cu), and alloys thereof. By forming the electrode part 220 using a metal, a resistance value of the electrode may be decreased and conductivity and detection sensitivity may be improved.

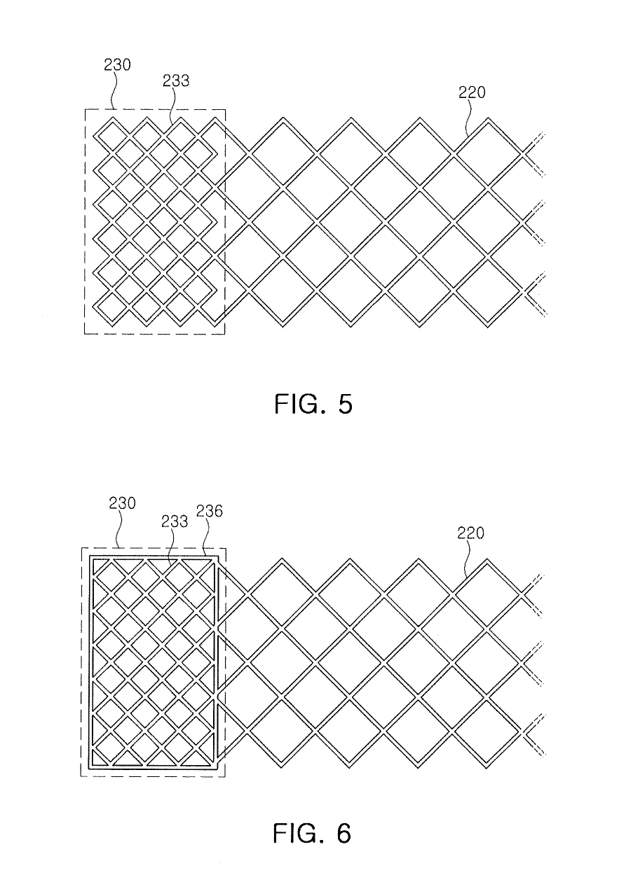

FIGS. 5 through 7 are views illustrating a pad part according to various exemplary embodiments of the present disclosure.

A pad according to the related art is not formed of the conductive lines having the mesh pattern but is formed of a single metal. In the case in which the pad is formed of the metal and the electrode is formed of the conductive line, the conductive line of the electrode disposed on the periphery of the pad may be disconnected due to different etching rates of the pad and the electrode. According to the present exemplary embodiment, such a disconnection of the conductive lines configuring the electrode part 220 may be prevented by forming the pad part 230 using the conductive lines having the mesh pattern.

Referring to FIG. 5, the pad part 230 may include pads 233, wherein the pads 233 may be formed of the conductive lines having the mesh pattern. The conductive lines of the pads 233 may have the same line width as the conductive lines of the electrode part 220. By setting the line widths of the conductive line of the pad 233 and the conductive line of the electrode part 220 to be equal, the etching rate of each conductive line may be equal, whereby a manufacturing process may be simplified. Specifically, the conductive line of the pad 233 and the conductive line of the electrode part 220 may have a line width of 2 to 10 μm.

In addition, similar to the conductive line of the electrode part 220, the conductive line of the pad part 230 may be formed of any one of silver (Ag), aluminum (Al), chrome (Cr), nickel (Ni), molybdenum (Mo), copper (Cu), and alloys thereof.

Each pad of the pad part 230 may have an opening rate lower than that of the electrode part 220, such that electrical conductivity of the pad part 230 may be secured. Specifically, the pad part 230 may have an opening rate of 60% to 95%.

Referring to FIG. 6, the pad part 230 may further include an outline 236 in addition to the pads 233. The outline 236 may be configured as a metal line of a quadrangular shape surrounding the pads 230. Therefore, electrical conductivity may be secured by additionally including the outline 236, even in the case in which portions of the conductive lines of the pad part 230 are disconnected. In this case, the outline may have a line width of 2 μm to 30 μm.

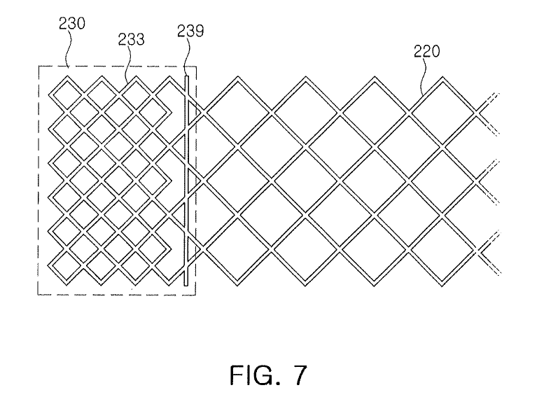

Referring to FIG. 7, the padpart 230 may further include an auxiliary line 239 in addition to the pads 233. The auxiliary line 239 may be spaced apart from the pads 233 by a predetermined distance or greater in a direction toward the electrode part 220. That is, the auxiliary line 239 may be overlapped with the electrode part 220. Therefore, the disconnection of the conductive line of the electrode part 220 disposed on the periphery of the pad part 230 may be more reliably prevented by forming the auxiliary line 239 and the conductive line of the electrode part 220 to be overlapped with each other. FIG. 7 illustrates that only a single auxiliary line is provided, but a plurality of auxiliary lines may be provided to prevent the disconnection of the conductive line of the electrode part 220. In this case, the auxiliary line 239 may have the same line width as the conductive line of the pad 233.

Although FIGS. 6 and 7 illustrate that the outline 236 and the auxiliary line 239 are separately provided in the pad part 230, the outline 236 and the auxiliary line 239 may be provided together with each other.

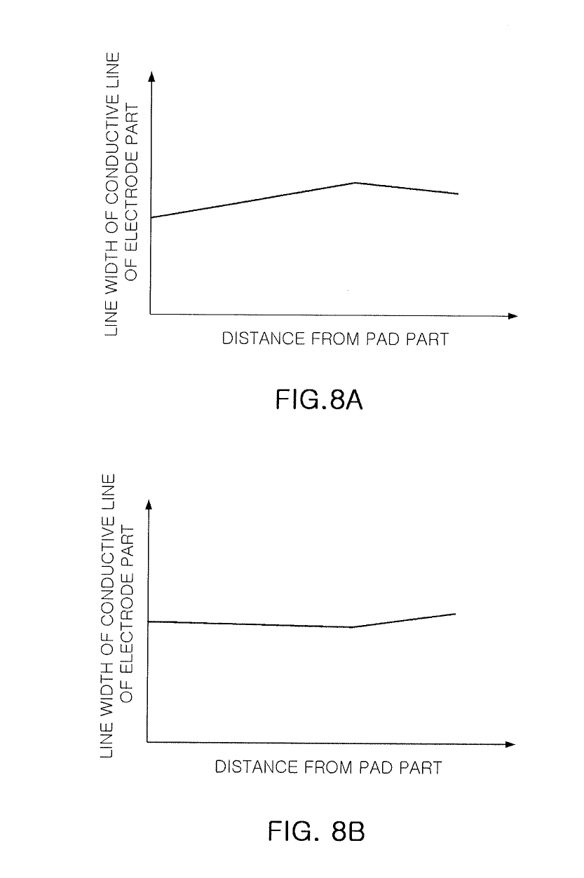

FIGS. 8A and 8B show simulation data according to an exemplary embodiment of the present disclosure. FIGS. 8A and 8B are graphs related to the line width of the conductive line of the electrode part according to a distance from the pad, wherein FIG. 8A shows data of a comparison example in which a pad is formed of a single metal and FIG. 8B shows data of an inventive example in which a pad is formed of conductive lines.

It may be appreciated from comparison results between FIGS. 8A and 8B that the line width of the conductive line of the electrode part non-ideally becomes narrow in a direction toward the pad as shown in FIG. 8A, but the above problem is solved as shown in FIG. 8B.

As set forth above, according to exemplary embodiments of the present disclosure, the pad is formed of the conductive line having a mesh pattern, whereby the disconnection of the conductive line of the electrode disposed on the periphery of the pad may be prevented.

In addition, the manufacturing process may be simplified by forming the conductive line of the pad and the conductive line of the electrode to have the same line width.

While exemplary embodiments have been shown and described above, it will be apparent to those skilled in the art that modifications and variations could be made without departing from the spirit and scope of the present disclosure as defined by the appended claims.

What is claimed is:

1. A touch panel comprising:
a substrate;
an electrode part including a plurality of electrodes formed on one surface of the substrate and formed of conductive lines having a mesh pattern; and
a pad part including a plurality of pads connected to end portions of the plurality of electrodes and formed of conductive lines having a mesh pattern,
wherein the conductive lines of the plurality of pads and the conductive lines of the plurality of electrodes have the same line width.

2. The touch panel of claim 1, wherein the conductive lines of the plurality of pads have a line width of 2 μm to 10 μm.

3. The touch panel of claim 1, wherein the pad part further includes a quadrangular outline surrounding the plurality of pads.

4. The touch panel of claim 3, wherein the outline has a line width of 2 μm to 30 μm.

5. The touch panel of claim 1, wherein the pad part further includes at least one auxiliary line spaced apart from the plurality of pads by a predetermined distance in a direction toward the electrode part.

6. The touch panel of claim 5, wherein the at least one auxiliary line has the same line width as that of the conductive lines of the plurality of pads.

7. The touch panel of claim 1, wherein the plurality of pads have an opening rate lower than that of the plurality of electrodes.

8. The touch panel of claim 4, wherein the plurality of pads have an opening rate of 60% to 95%.

9. The touch panel of claim 1, wherein the conductive lines of the plurality of pads are formed of at least one of silver (Ag), aluminum (Al), chrome (Cr), nickel (Ni), molybdenum (Mo), copper (Cu), and alloys thereof.

10. A touch panel comprising:
a substrate;
an electrode part including a plurality of electrodes formed on one surface of the substrate and formed of conductive lines having a mesh pattern; and
a pad part including a plurality of pads connected to end portions of the plurality of electrodes and formed of conductive lines having a mesh pattern and at least one auxiliary line spaced apart from the plurality of pads by a predetermined distance in a direction toward the electrode part.

11. touch panel of claim 10, wherein the conductive lines of the plurality of pads and the conductive lines of the plurality of electrodes have the same line width.

12. The touch panel of claim 11, wherein the conductive lines of the plurality of pads have a line width of 2 μm to 10 μm.

13. The touch panel of claim 10, wherein the pad part further includes a quadrangular outline surrounding the plurality of pads.

14. The touch panel of claim 13, wherein the outline has a line width of 2 μm to 30 μm.

15. The touch panel of claim 10, wherein the at least one auxiliary line has the same line width as that of the conductive lines of the plurality of pads.

16. The touch panel of claim 10, wherein the plurality of pads have an opening rate lower than that of the plurality of electrodes.

17. The touch panel of claim 16, wherein the plurality of pads have an opening rate of 60% to 95%.

18. The touch panel of claim 10, wherein the conductive lines of the plurality of pads are formed of at least one of silver (Ag), aluminum (Al), chrome (Cr), nickel (Ni), molybdenum (Mo), copper (Cu), and alloys thereof.
